(19) United States
(12) Patent Application Publication
(10) Pub. No.: US 2022/0114654 A1
(43) Pub. Date: Apr. 14, 2022

(54) METHOD, SYSTEM, AND DEVICE FOR FASHION SOCIAL NETWORKING

(71) Applicant: Matthew Benoit, Montreal (CA)

(72) Inventor: Matthew Benoit, Montreal (CA)

(21) Appl. No.: 17/528,880

(22) Filed: Nov. 17, 2021

(51) Int. Cl. G06Q 30/06; G06Q 50/00

(52) U.S. Cl. CPC G06Q 30/0643; G06Q 50/01; G06Q 30/0621; G06Q 30/0603

(57) ABSTRACT

The invention provides a method and system for exchanging fashion information. The processor receives an input of a first catalogue from a first brand and a second catalogue from a second brand. The processor transfers the first and second catalogue to a stylist user device. An ensemble is generated using a first item from the first catalogue and a second item from the second catalogue. The ensemble is superimposed on a 3D model avatar in a virtual reality environment.

### FIELD OF THE INVENTION

This invention relates to a new and improved fashion social network system and method.

### BACKGROUND

The fashion industry has tremendously grown with the expansion of the internet. Experts have stated that the global online fashion market will grow at a tremendous rate in the coming years. The advancement of social networking platforms have increased the connectedness, innovation, and diversity of the fashion industry. However, there is still a need for a social networking platform that connects brands based on their current inventory, fashion stylists, and consumers.

### SUMMARY OF THE INVENTION

It is essential to the present disclosure, all embodiments are provided as illustrative and non-limiting representatives of various possible embodiments. In addition, the terms “is”, “can”, “will” and the like are herein uses as synonyms for an interchangeable with terms such as “may” “may provide for”, and “it is contemplated that the present invention may” and so forth.

Furthermore, all elements listed by name, encompass all equivalents for such elements. Such equivalents are contemplated for each element named herein.

For purposes of summarizing, certain aspects, advantages, and novel features of the present invention are provided herein. It is to be understood that not all aspects, advantages, or novel features may be provided in any one particular embodiment. Thus, the disclosed subject matter may be embodied or carried out in a manner that achieves or optimizes one aspect, advantages, or novel features or group of features without achieving all aspects, advantages, or novel features as may be taught or suggested.

The market currently lacks a social networking platform that connects brands based on their current inventory, fashion stylists, and consumers. More specifically, there is a need for a social platform where fashion stylists can create ensemble combinations specifically based on inputted brand catalogues. Attempts have been made, although unsuccessful to solve this problem.

One illustrative attempt to solve the problem is the application software called dress me up app. This application software generates a look of the day for a user based on items already owned by the user. The app also suggest single items for purchase by a user based on popularity. While this disclosure generally discloses the creation of ensembles for a user, it does not disclose the creation of ensembles for a user based on items not yet purchased by the user and with the input of a fashion stylist.

Another attempt can be seen with respect to U.S. Pat. No. 9,070,171, which generally discloses a client server social-network for providing automated clothing suggestions. The disclosure generally discloses a software that allows a user to combine various wardrobe items, and visualize items and outfits by use of a virtual mannequin. However, the disclosure does not disclose the creation of ensembles for a user based on items not yet purchased by the user and with the input of a fashion stylist. In view of the foregoing disadvantages inherent in the known art, the present invention provides a novel solution for this problem.

The features of the invention, which are believed to be novel, are particularly pointed out and distinctly claimed in the concluding portion of the specification. These and other features, aspects, and advantages of the present invention will become better understood with reference to the following drawings and detailed description.

In an embodiment the invention provides a method for exchanging fashion information. The processor receives an input of a first catalogue from a first brand and a second catalogue from a second brand. The processor transfers the first and second catalogue to a stylist user device. An ensemble is generated using a first item from the first catalogue and a second item from the second catalogue. The ensemble is superimposed on a 3D model avatar in a virtual reality environment.

In a second embodiment the invention provides a system for exchanging fashion information. The processor receives an input of a first catalogue from a first brand and a second catalogue from a second brand. The processor transfers the first and second catalogue to a stylist user device. An ensemble is generated using a first item from the first catalogue and a second item from the second catalogue. The ensemble is superimposed on a 3D model avatar in a virtual reality environment.

In a third embodiment the invention provides a device for exchanging fashion information. The processor receives an input of a first catalogue from a first brand and a second catalogue from a second brand. The processor transfers the first and second catalogue to a stylist user device. An ensemble is generated using a first item from the first catalogue and a second item from the second catalogue. The ensemble is superimposed on a 3D model avatar in a virtual reality environment.

The embodiments of the invention described herein are exemplary and numerous modifications, variations, and rearrangements can be readily envisioned to achieve substantially equivalent results, all of which are intended to be embraced within the spirit and scope of the invention. Furthermore, while the preferred embodiment of the invention has been described in terms of the components and configurations, it is understood that the invention is not limited to those specific dimensions or configurations but is to be accorded the full breadth of the spirit of the invention.

### BRIEF DESCRIPTION OF THE DRAWINGS

These and other features, aspects and advantages of the present invention will become better understood with regard to the following description, appended claims, and accompanying figures.

FIG. 1 shows the network connections between the devices in the environment, which are capable of implementing the present embodiments.

FIG. 2 is an exemplary illustrative network environment where various embodiments of the present invention are said to function.

FIG. 3 is an exemplary illustrative embodiment of the present invention.

FIG. 4A is an exemplary illustration where various embodiments of the present invention are said to function.

FIG. 4B is an exemplary illustrative stylist profile where various embodiments of the present invention are said to function.

FIG. 4C is an exemplary illustration where various embodiments of the present invention are said to function.

FIG. 4D is an exemplary illustration where various embodiments of the present invention are said to function.

FIG. 5 is an exemplary illustrative flow chart of the present invention.

FIG. 6 is an exemplary illustrative flow chart depicting the various processor executions of the present invention.

### DETAILED DESCRIPTION

The present invention overcomes the limitations of the prior art by providing a novel method and device for fashion social networking.

It is essential to understand that the drawings and the associated descriptions are provided to illustrate potential embodiments of the invention and not to limit the scope of the invention. Reference in the specification to “one embodiment” or “an embodiment” is intended to indicate that a particular feature, structure, or characteristics described in connection with the embodiment is included in at least an embodiment of the invention. The appearances of the phrases “in one embodiment” or “an embodiment” in various places in the specification are not necessarily all referring to the same embodiment.

As used in this disclosure, except where the context requires otherwise, the term “comprise” and various of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may be shown in detail in order not to obscure the embodiments.

The system of the present invention is suitable for a fashion social networking device and method.

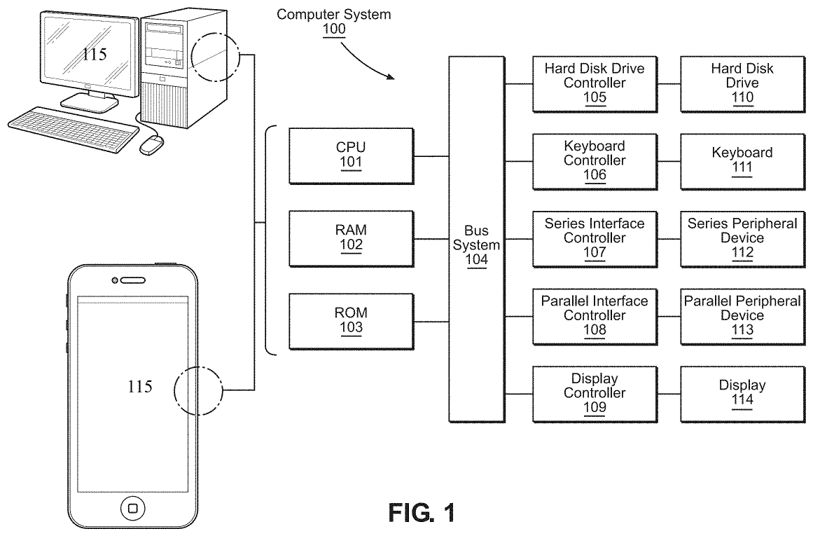

FIG. 1 shows the network connections between the devices in the environment, which are capable of implementing the present embodiments.

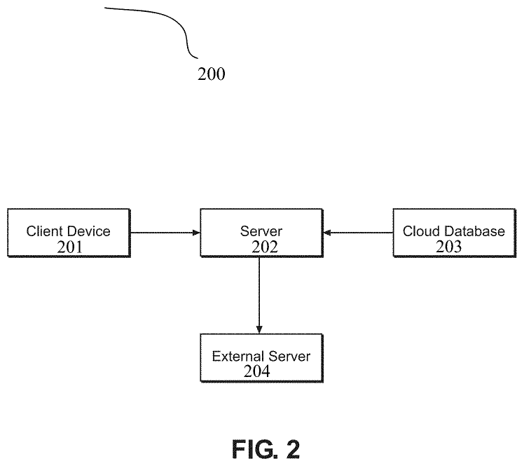

FIG. 2 is an exemplary illustrative network environment where various embodiments of the present invention are said to function.

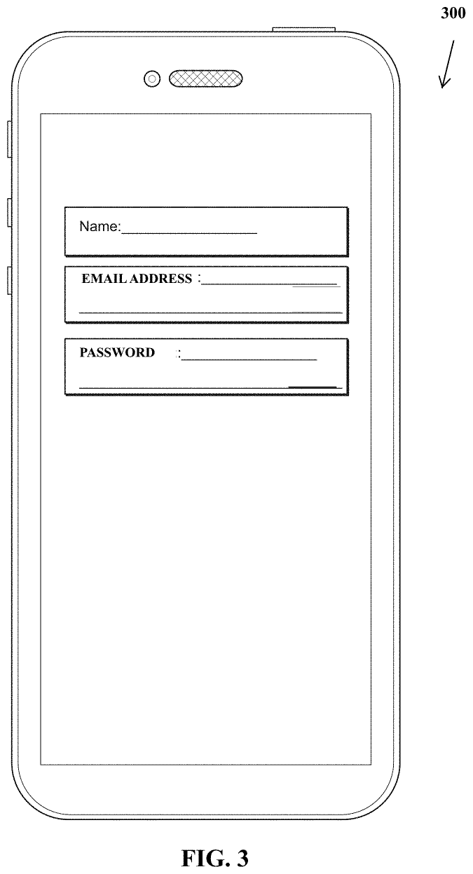

FIG. 3 is an exemplary illustrative embodiment of the present invention.

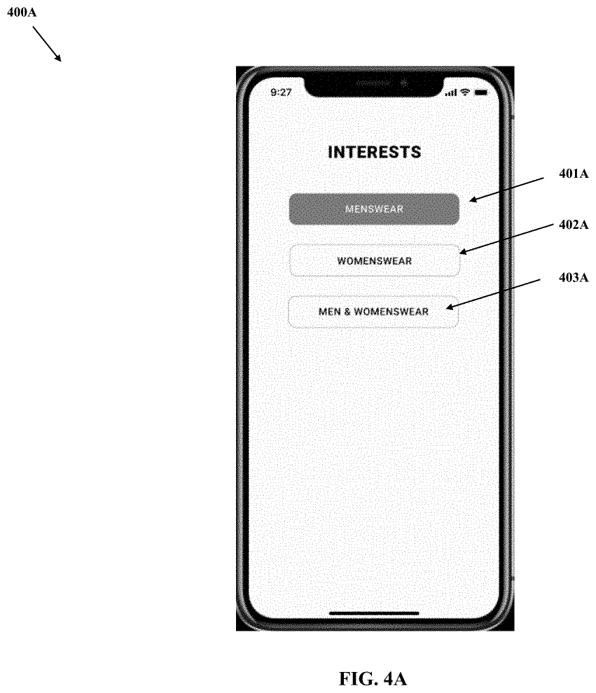

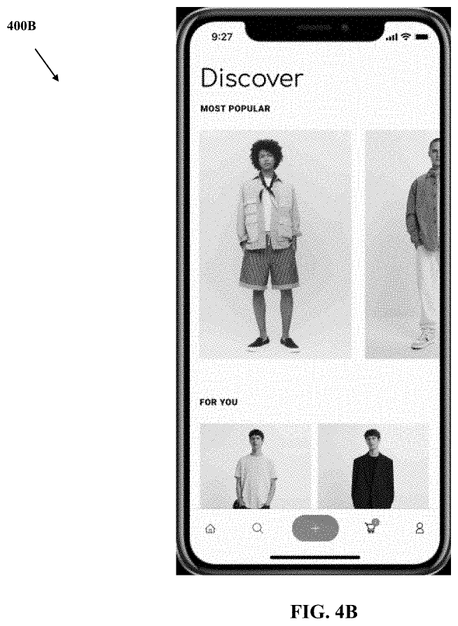

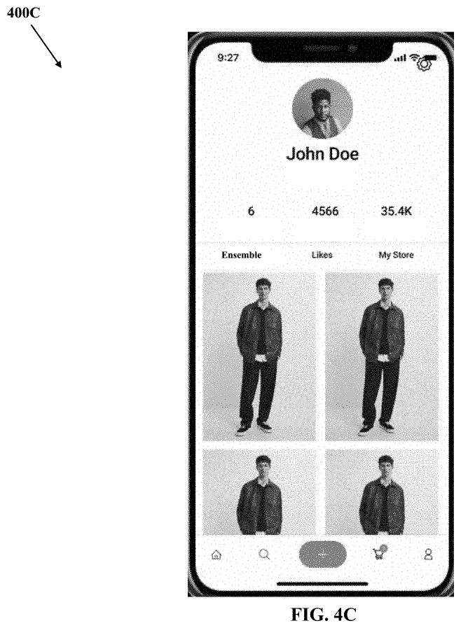

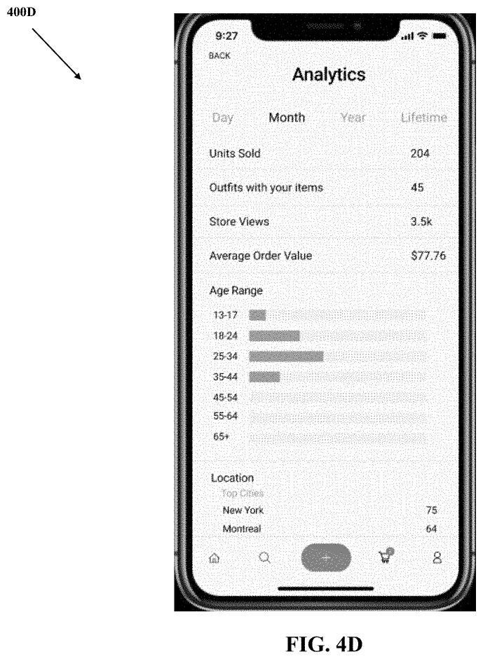

FIG. 4A is an exemplary illustration where various embodiments of the present invention are said to function.

FIG. 4B is an exemplary illustrative stylist profile where various embodiments of the present invention are said to function.

FIG. 4C is an exemplary illustration where various embodiments of the present invention are said to function.

FIG. 4D is an exemplary illustration where various embodiments of the present invention are said to function.

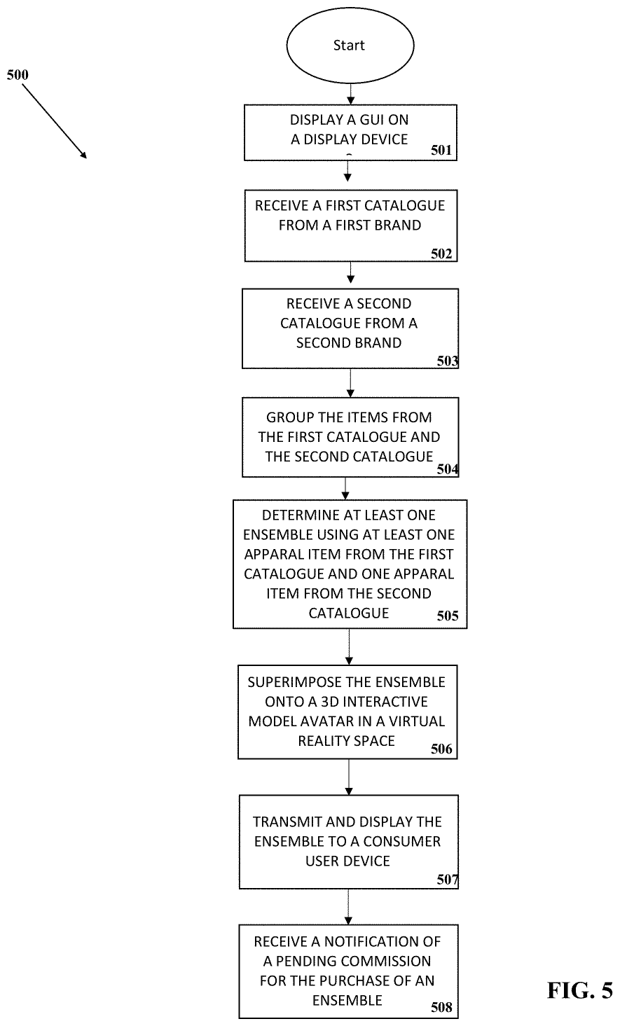

FIG. 5 is an exemplary illustrative flow chart of the present invention.

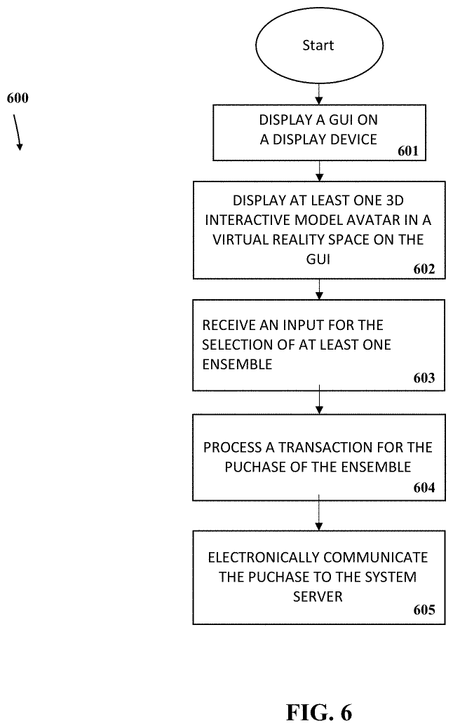

FIG. 6 is an exemplary illustrative flow chart depicting the various processor executions of the present invention.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in the disclosure.

FIG. 1 shows the network connections between the devices in the environment, which are capable of implementing the present embodiments. Computing device 115 can be of a portable device or a non-portable device. Client device 115 may be a handheld device, a mobile device, a smartphone, a personal digital assistant (PDA), a personal computer, netbook, laptop, a tablet, or similar computer system devices equipped with a wireless transceiver providing the communication interface. The client device may comprise of a central processing unit 101, a random-access memory 102, a read only memory 103, at least one bus 104, a plurality of controllers 105-109, a plurality of ports, such as a USB port, a plurality of data storage devices 110, such as a hard disk drive or a flash memory, a keyboard 111, a series and parallel peripheral device 112-113, and a display 114. Client device 115 may comprise of an operating module working conjointly with the processor to execute a plurality of machine learning algorithms, the data and models of which are stored in memory. Client device 115 may further be of an audio interface, a video interface, a network interface, an input-output interface, and at least one display. Client device 115 may be connected to at least one Server 102 as displayed in FIG. 2. Turning attention to FIG. 2.

FIG. 2 is an exemplary illustrative network environment where various embodiments of the present invention are said to function. Client device 201 may be connected to at least one Server 202. Server 202 may be connected to at least one external server and or a central Database 203. Database 203 may comprise of a cloud-based server and may further include at least one archived database. Server 202 is configured to receive and transmit information between the client device 201 and database 203. Server 202 may comprise of system to run server applications, to maintain the databases, and a network to connect devices to the internet. The network may comprise of a communication interface.

The communication interface can be a wired or wireless interface. The communication interface can be a short-range communication interface such as WiFi, WiFi-direct, Bluetooth, ZigBee, WiMedia UWB, Infra Red, and any similar technology. The network may comprise of a local area network (LAN), a wide-area network (WAN), or the internet. The communication interface connects the client devices 201 with the server 202 and the database 203. The client device, the server, and the database having the necessary hardware and or software functionalities. The client device can utilize any traditional mobile or wireless infrastructure, based network such as CDMA. Further, the CDMA network may implement a radio technology such as Universal Terrestrial Radio Access (UTRA) and CDMA2000. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM) and General Packet Radio Service (GPRS). An OFDMA network may implement a radio technology such as Evolved UTRA (E-UTRA), Ultra Mobile Broadband (UMB), IEEE 802.11 (WiFi). IEEE 802.16 (WiMAX), IEEE 802.20, Flash-OFDM. The network allows the client device, the server, and the databases to intermittently communicate. Turning attention to FIG. 3.

FIG. 3 is an exemplary illustrative embodiment of the present invention. The algorithm may execute as a web application or a mobile application. The mobile application may be a stand-alone or a non-stand-alone application. The invention is geared towards the fashion industry. The system may also be applied to various related and non-related industries. Users of client device 115 may create an account by entering, for example, a name, an email, a password, and other similar identifying information. A user of the application software may be a brand, a stylist, and or a consumer. Users may also create an account by signing into a third-party portal such as Facebook, Twitter, Google, or other email address. The system may generate a protocol to verify the user's identity based on the known information from the third-party server. Generally, the invention may comprise of a separate interface for a stylist, a consumer, and a brand manufacturer. Turning attention to FIG. 4A.

FIG. 4A is an exemplary illustration where various embodiments of the present invention are said to function. The system may display a selection module 400A on a consumer user device. The server may generate, and display on a GUI, a set of inquiries for the user. For example, a user may be asked to select either menswear 401A, womenswear 402A, or both 403A. Upon an input by the user, the server may generate and display the most popular items and ensembles generated and transmitted by a stylist user device. An ensemble may be for example at least one combination of apparel items, as shown in FIG. 4B. Turning attention to FIG. 4C.

FIG. 4C is an exemplary illustration where various embodiments of the present invention are said to function. The stylist user device 400C may comprise of a plurality of data. The data may include a plurality of ensembles generated through a set of inputs on the device 401C. The data may also include a system generated list of ensembles marked as favored by third party devices on the application 402C. The data may further include a list of merchant partners of the user of the stylist user device 403C. Turning attention to FIG. 4D.

FIG. 4D is an exemplary illustration where various embodiments of the present invention are said to function. The stylist user device may further display an analytics module, which may include a plurality of computed data 400D. For example, the computations may include the total units sold by a merchant partner, the total ensembles with the merchant partner's items in use, the total views gained on the portal for each merchant partner, the average order value of items purchased on the merchant partner's portal, the age range of consumers the merchant partners' apparel items attract, and the location of purchasers of the items the merchant partners attract. A merchant partner may be for example, a brand or manufacturer with the apparel items for sale. A merchant partner may transmit at least one catalogue of apparel items from a merchant database to the server of the application software. Turning attention to FIG. 5.

FIG. 5 is an exemplary illustrative flow chart of the present invention. At step 501, the system displays a GUI on a display device. At step 502 the processor receives a first catalogue from a first brand. At step 503 the processor receives a second catalogue from a second brand. The first and second catalogue may be from the same brand or separate brands. A catalogue entry may be for example, the current apparel inventory of a brand, a store, or a marketer. At step 504 the processor stores the catalogue and groups the items on the catalogue based on a predetermined category. The category may be based on style, color, or any similar designation. At step 505 the system determines at least one ensemble. The system may create the ensemble with a first item from a first catalogue and a second item from a second catalogue. The ensemble may be manually or automatically created by system settings.

The ensemble may be manually created by a user of the stylist user device or automatically created by system settings. As to the automatic generation of an ensemble, the system may generate at least one combination based on a set of predetermined classifications. For example, the classifications may be of a color, a pattern, or length. The server will use these predetermined classifications to generate at least one combination with at least one item from the first brand, and at least one item from the second brand. At step 506 the system superimposes the ensemble onto a model avatar. The system may generate and display the image of the model avatar with the ensemble on a stylist GUI. The processor is configured to simulate a virtual reality environment and simulate a 3D interactive model avatar through the environment. At step 507 the system displays the image of the model with the ensemble on a consumer device. A user may select the ensemble for purchase from a consumer user device. The server may generate a purchase of the ensemble from the consumer user device. The server may compute a commission based on the purchased ensemble and store the commission on the stylist device payment database. At step 508, the stylist user device may receive a notification of a pending commission for the purchased ensemble. The server may automatically update the inventory of the first brand and the second brand to reflect the purchase of the ensemble. Turning attention to FIG. 6.

FIG. 6 is an exemplary illustrative flow chart depicting the various processor executions of the present invention. At step 600 a GUI is displayed on the consumer user device. At step 601, at least one ensemble is displayed on the GUI. At step 602, the device receives a user selection of an ensemble. At step 603, a transaction is processed for the purchase of the ensemble. At step 604, a transaction is processed on the application interface for the purchase of the ensemble. At step 605, the purchase data is electronically communicated to the system server. A commission is computed based on the purchase data. The computed commission may be a percent value of the total cost of the ensemble. The purchase data is also communicated to the server to update the catalogue of the first brand and the second brand.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations were at least some of such features and/or steps are mutually exclusive. Each feature disclosed in the specification, including the claims, abstract and drawings, can be replaced by alternative features serving the same, equivalent or similar purpose, unless expressly stated otherwise. Thus, unless expressly stated otherwise, each feature disclosed is one example only of a generic series of equivalent or similar features.

While the present invention has been disclosed in connection with a number of embodiments shown and described in detail, various modifications should be readily apparent to those of skill in the art.

What is claimed is:

1. A method for exchanging fashion information comprising an algorithm executing on at least one processor for:
receiving an input of a first catalogue;
receiving an input of a second catalogue;
transferring the first catalogue to a stylist user device;
transferring the second catalogue to the stylist user device;
generating a first combination from the first catalogue and the second catalogue;
superimposing the first combination on a 3D model avatar in a virtual reality environment;
displaying the 3D model avatar on the stylist user device GUI;
displaying the 3D model avatar on a consumer user device GUI;
processing a purchase for the first combination from the consumer user device;
calculating a commission based on the transaction; and
storing the commission in a stylist user device payment database.

2. The method for exchanging fashion information of claim 1, wherein the first catalogue comprises of a first set of apparel items.

3. The method for exchanging fashion information of claim 1, wherein the second catalogue comprise of a second set of apparel items.

4. The method for exchanging fashion information of claim 1, wherein the first catalogue is transmitted by a first brand database and the second catalogue is transmitted by a second brand database.

5. The method for exchanging fashion information of claim 1, wherein the first catalogue and the second catalogue are transmitted by the first brand database.

6. The method for exchanging fashion information of claim 4, wherein the first brand database and the second database are automatically updated to reflect a current inventory; wherein a second combination is automatically generated based on the availability of an apparel item in the current inventory.

7. The method for exchanging fashion information of claim 1, wherein the first combination is generated by a user on a stylist user device

8. The method for exchanging fashion information of claim 1, wherein the first combination is automatically generated based on predetermined inputs on a stylist user device.

9. The method for exchanging fashion information of claim 1, wherein the predetermined inputs is at least one of a color, a pattern, or a length.

10. The method for exchanging fashion information of claim 6, wherein the second combination include at least one item from the first catalogue and at least one item from the second catalogue.

11. A method for exchanging fashion information comprising an algorithm executing on at least one processor for:
receiving an input of a first catalogue;
receiving an input of a second catalogue;
transferring the first catalogue to a stylist user device;
transferring the second catalogue to the stylist user device;
generating a first combination from the first catalogue and the second catalogue;
superimposing the first combination on a 3D model avatar in a virtual reality environment;
displaying the 3D model avatar on the stylist user device GUI;
displaying the 3D model avatar on a consumer user device GUI;
processing a purchase for the first combination from the consumer user device;
calculating a commission based on the transaction; and
storing the commission in a stylist user device payment database.

12. The method for exchanging fashion information of claim 11, wherein the first catalogue comprises of a first set of apparel items.

13. The method for exchanging fashion information of claim 11, wherein the second catalogue comprise of a second set of apparel items.

14. The method for exchanging fashion information of claim 11, wherein the first catalogue is transmitted by a first brand database and the second catalogue is transmitted by a second brand database.

15. The method for exchanging fashion information of claim 11, wherein the first combination is generated based on predetermined inputs on a stylist user device.

16. A method for exchanging fashion information comprising an algorithm executing on at least one processor for:
receiving an input of a first catalogue;
receiving an input of a second catalogue;
transferring the first catalogue to a stylist user device;
transferring the second catalogue to the stylist user device;
generating a first combination from the first catalogue and the second catalogue;
superimposing the first combination on a 3D model avatar in a virtual reality environment;
displaying the 3D model avatar on the stylist user device GUI;
displaying the 3D model avatar on a consumer user device GUI;
processing a purchase for the first combination from the consumer user device;
calculating a commission based on the transaction; and
storing the commission in a stylist user device payment database.

17. The method for exchanging fashion information of claim 16, wherein the first catalogue comprises of a first set of apparel items.

18. The method for exchanging fashion information of claim 16, wherein the second catalogue comprise of a second set of apparel items.

19. The method for exchanging fashion information of claim 16, wherein the first catalogue is transmitted by a first brand database and the second catalogue is transmitted by a second brand database.

20. The method for exchanging fashion information of claim 16, wherein the first combination is generated based on predetermined inputs on a stylist user device.
